(19) United States
(12) Patent Application Publication
(10) Pub. No.: US 2016/0210642 A1
(43) Pub. Date: Jul. 21, 2016

(54) PRIORITY-BASED DEMAND CONTROL DEVICE AND METHOD, PRIORITY DETERMINATION DEVICE AND METHOD, AND RECORDING MEDIUM HAVING PROGRAM THEREFOR RECORDED THEREON

(71) Applicant: SAMSUNG SDS CO., LTD., Seoul (KR)

(72) Inventors: Kang Hyoung CHO, Seoul (KR); Min Goo KANG, Pyeongtaek-si (KR); Sung Youn KIM, Seoul (KR)

(73) Assignee: SAMSUNG SDS CO., LTD., Seoul (KR)

(21) Appl. No.: 15/025,080

(22) PCT Filed: Sep. 25, 2014
(86) PCT No.: PCT/KR2014/008924

§ 371 Date: Mar. 25, 2016

(30) Foreign Application Priority Data
Sep. 25, 2013 (KR) 10-2013-0113891

(51) Int. Cl. G06Q 30/02

(52) U.S. Cl. CPC G06Q 30/0202

(57) ABSTRACT

Priority-based demand control device and method, priority determination device and method, and a recording medium recorded with a program thereof are provided, which can assign priorities to confirmed demands that form basic information for establishing supply plans and can control the demands using the assigned priorities. The priority determination device may include a demand information input unit receiving an input of confirmed demand information that includes information on preset items including an item related to a demand request time from respective low-level sales organizations, an item rank determination unit determining rank values for the preset items using the received confirmed demand information, and a comprehensive rank value determination unit determining a comprehensive priority value through arrangement of the rank values for the respective preset items that are determined by the item rank determination unit in accordance with a preset rule.

### TECHNICAL FIELD

The present invention relates to priority-based demand control device and method, priority determination device and method, and a recording medium recorded with a program thereof. More particularly, the present invention relates to priority-based demand control device and method, priority determination device and method, and a recording medium recorded with a program thereof, which can assign priorities to confirmed demands that form basic information for establishing supply plans and can control the demands using the assigned priorities.

### BACKGROUND ART

A sales organization of an enterprise may mostly have a layered structure. Respective sales levels of the layered structure may have corresponding sales regions.

On the other hand, for forecasted demand and production management of the enterprise, persons in charge of the respective sales levels may calculate forecasted demand quantities with respect to the levels of which they take charge and may input the calculated forecasted demand quantities to an in-house computation system.

In the case of confirming the demands using the input forecasted demand quantities in the related art, assignment of the priorities to the confirmed demands and control of the demand quantity in consideration of profitability and strategy of the enterprise have not been properly performed.

Further, in the related art, the reference and method for assigning the priorities to the confirmed demands and controlling the demand quantity are unable to be flexibly changed.

Further, the method in the related art is not generally applied in accordance with a category of business to which the enterprise belongs and the market, but is implemented in a specified direction.

Accordingly, there has been a need for technology that can determine the priorities of the confirmed demands and can control the demand quantities in customer-oriented, flexible, and standardized manners.

### DISCLOSURE

### Technical Problem

Accordingly, the present invention has been made to solve the above-mentioned problems occurring in the related art, and a subject to be achieved by the present invention is to provide a device and a method for determining priorities of confirmed demands.

Another subject to be achieved by the present invention is to provide a device and a method for determining priorities of confirmed demands, which can be flexibly applied even in various business types and market conditions.

Still another subject to be achieved by the present invention is to provide a device and a method for determining priorities, which can respect priority determination methods for several sales organizations and can prevent the priorities of other sales organizations from becoming unprofitable due to the respect of the priority determination method of a specific sales organization.

Still another subject to be achieved by the present invention is to provide a device and a method for determining priorities that can be structured, standardized, and flexibly changed in accordance with the market change, strategy of an enterprise, and product profitability.

Still another subject to be achieved by the present invention is to provide a device and a method for controlling demands, which can control the total quantity of confirmed demands.

Additional advantages, subjects, and features of the invention will be set forth in part in the description which follows and in part will become apparent to those having ordinary skill in the art upon examination of the following or may be learned from practice of the invention.

### Technical Solution

In a first aspect of the present invention, there is provided a priority determination device, which includes a demand information input unit configured to receive an input of confirmed demand information that includes information on preset items including a week rank that is an item related to a demand request time from respective low-level sales organizations; an item rank determination unit configured to determine rank values for the preset items using the received confirmed demand information; a lead time correction unit configured to correct the determined rank value of the week rank among the determined rank values for the preset items in consideration of a lead time; a comprehensive rank value determination unit configured to determine a comprehensive priority value through arrangement of the determined rank values for the preset items that are corrected by the lead time correction unit in accordance with a preset rule; and a priority determination unit configured to determine priorities of the confirmed demands of the sales organizations using the comprehensive priority value.

The preset rule may include a high-level rule that is determined by the highest-level organization and a low-level rule that is determined by the low-level organization that is not the highest-level organization, and the comprehensive rank value determination unit may determine the comprehensive priority value through the arrangement of the determined rank values for the preset items that are corrected by the lead time correction unit in accordance with at least one of the high-level rule and the low-level rule.

The priority determination unit may determine a priority PR1 using the comprehensive priority value that is determined using the high-level rule, and if there exist the sales organizations having the low-level rule among the sales organizations, the priority determination unit may determine a priority PR2 between the sales organizations that adopt the same low-level rule on the basis of the comprehensive priority value that is determined using the low-level rule, and the priority determination unit may reflect the priority PR2 that is determined by the low-level rule in the priority PR1 that is determined using the high-level rule.

The preset items may include at least one of a preference rank that is an item related to importance of a customer, a demand type rank that is an item related to a demand type, a measurement rank that is an item related to an information input subject, an order type rank that is an item related to an order attribute, a customer rank that is an item related to a customer according to profit and loss results, and a product rank that is an item related to products according to profit and loss results.

The item rank determination unit may determine the rank value of the week rank with a two-digit number, and may determine the rank values of the preset items except for the week rank with one-digit numbers.

In a second aspect of the present invention, there is provided a priority determination method, which includes a demand information input step of receiving an input of confirmed demand information that includes information on preset items including a week rank that is an item related to a demand request time from respective low-level sales organizations; an item rank determination step of determining rank values for the preset items using the received confirmed demand information; a lead time correction step of correcting the determined rank value of the week rank among the determined rank values for the preset items in consideration of a lead time; a comprehensive rank value determination step of determining a comprehensive priority value through arrangement of the determined rank values for the preset items that are corrected by the lead time correction step in accordance with a preset rule; and a priority determination step of determining priorities of the confirmed demands of the sales organizations using the comprehensive priority value.

The preset rule may include a high-level rule that is determined by the highest-level organization and a low-level rule that is determined by the low-level organization that is not the highest-level organization, and the comprehensive rank value determination step may determine the comprehensive priority value through the arrangement of the determined rank values for the preset items that are corrected by the lead time correction step in accordance with at least one of the high-level rule and the low-level rule.

The priority determination step may determine a priority PR1 using the comprehensive priority value that is determined using the high-level rule, and if there exist the sales organizations having the low-level rule among the sales organizations, the priority determination step may determine a priority PR2 between the sales organizations that adopt the same low-level rule on the basis of the comprehensive priority value that is determined using the low-level rule, and the priority determination step may reflect the priority PR2 that is determined by the low-level rule in the priority PR1 that is determined using the high-level rule.

The preset items may include at least one of a preference rank that is an item related to importance of a customer, a demand type rank that is an item related to a demand type, a measurement rank that is an item related to an information input subject, an order type rank that is an item related to an order attribute, a customer rank that is an item related to a customer according to profit and loss results, and a product rank that is an item related to products according to profit and loss results.

In a third aspect of the present invention, there is provided a priority-based demand control device, which includes a demand information input unit configured to receive an input of confirmed demand information that includes information on preset items including a week rank that is an item related to a demand request time from respective low-level sales organizations; an item rank determination unit configured to determine rank values for the preset items using the received confirmed demand information; a lead time correction unit configured to correct the determined rank value of the week rank among the determined rank values for the preset items in consideration of a lead time; a comprehensive rank value determination unit configured to determine a comprehensive priority value through arrangement of the determined rank values for the preset items that are corrected by the lead time correction unit in accordance with a preset rule; a priority determination unit configured to determine priorities of the confirmed demands of the sales organizations using the comprehensive priority value; and a demand control unit configured to successively distribute predetermined supply plan quantities in the order of the determined priorities of the confirmed demands.

The demand control unit may successively distribute the predetermined supply plan quantities in the order of the determined priorities of the confirmed demands if the predetermined product quantity is smaller than the total quantity of the confirmed demands input by the sales organizations, and may perform a stock-out process with respect to the confirmed demand which has low priority and to which the supply plan quantity is not distributed so as not to establish the supply plan.

In a fourth aspect of the present invention, there is provided a priority-based demand control method, which includes a demand information input step of receiving an input of confirmed demand information that includes information on preset items including a week rank that is an item related to a demand request time from respective low-level sales organizations; an item rank determination step of determining rank values for the preset items using the received confirmed demand information; a lead time correction step of correcting the determined rank value of the week rank among the determined rank values for the preset items in consideration of a lead time; a comprehensive rank value determination step of determining a comprehensive priority value through arrangement of the determined rank values for the preset items that are corrected by the lead time correction step in accordance with a preset rule; a priority determination step of determining priorities of the confirmed demands of the sales organizations using the comprehensive priority value; and a demand control step of successively distributing predetermined supply plan quantities in the order of the determined priorities of the confirmed demands.

The demand control step may successively distribute the predetermined supply plan quantities in the order of the determined priorities of the confirmed demands if the predetermined product quantity is smaller than the total quantity of the confirmed demands input by the sales organizations, and may perform a stock-out process with respect to the confirmed demand which has low priority and to which the supply plan quantity is not distributed so as not to establish the supply plan.

In a fifth aspect of the present invention, there is provided a computer readable recording medium recorded with a program that performs receiving an input of confirmed demand information that includes information on preset items including a week rank that is an item related to a demand request time from respective low-level sales organizations; determining rank values for the preset items using the received confirmed demand information; correcting the determined rank value of the week rank among the determined rank values for the preset items in consideration of a lead time; determining a comprehensive priority value through arrangement of the determined rank values for the preset items that are corrected by the lead time correction in accordance with a preset rule; and determining priorities of the confirmed demands of the sales organizations using the comprehensive priority value.

### Advantageous Effects

The present invention can provide a device and a method for determining priorities of confirmed demands.

Further, the present invention can determine priorities of confirmed demands, which can be flexibly applied even in various business types and market conditions.

Further, the present invention can determine priorities that can be structured, standardized, and flexibly changed in accordance with the market change, strategy of an enterprise, and product profitability.

Further, the present invention can determine priorities, which can respect priority determination methods for several sales organizations and can prevent the priorities of other sales organizations from becoming unprofitable due to the respect of the priority determination method of a specific sales organization.

Further, the present invention can promptly apply product supply plans through determination of the priorities of the confirmed demands and can efficiently and continuously maintain and manage the demands and the supply plans.

Further, the present invention can control the total quantity of the confirmed demands in accordance with the demand conditions, supply conditions, and market conditions.

The effects of the present invention are not limited to the above-described effects, and other unmentioned effects will be clearly understood to those skilled in the art from the description of claims.

### DESCRIPTION OF DRAWINGS

The above and other subjects, features and advantages of the present invention will be more apparent from the following detailed description taken in conjunction with the accompanying drawings, in which:

FIG. 1 is a diagram illustrating a forecasted demand and supply plan establishment process;

FIG. 2 is a diagram illustrating an example of an organizational layer that determines priorities of confirmed demands of an enterprise having a global sales network;

FIG. 3 is a diagram illustrating an example of preset items;

FIG. 4 is a flowchart explaining a priority determination method and a priority-based demand control method according to the present invention;

FIG. 5 is a block diagram of a priority determination device according to an embodiment of the present invention;

FIG. 6 is a diagram illustrating an example in which rank values for items are determined by an item rank determination unit;

FIG. 7 is a diagram explaining an example in which rank values for week time items are corrected by a lead time correction unit;

FIG. 8 is a diagram illustrating an example of a sales organization layer;

FIG. 9 is a diagram explaining an example in which a preset rule is differently applied in accordance with conditions;

FIG. 10 is a diagram illustrating an example in which a high-level rule and a low-level rule are set;

FIG. 11 is a diagram illustrating an example of a comprehensive priority value determined by a comprehensive rank value determination unit;

FIG. 12 is a diagram illustrating an example in which a comprehensive rank value determination unit determines a comprehensive priority value using a high-level rule for respective confirmed demands;

FIG. 13 is a diagram illustrating an example in which a comprehensive rank value determination unit determines a comprehensive priority value using a low-level rule in consideration of the characteristic of France;

FIG. 14 is a diagram explaining the results of reflection of the contents of FIG. 13 in the example of FIG. 12 through a priority determination unit that performs priority swapping;

FIG. 15 is a block diagram of a priority-based demand control device according to an embodiment of the present invention;

FIG. 16 is a diagram illustrating an example in which demand request quantities for respective confirmed demands are aligned in the priority order determined by a priority determination unit;

FIG. 17 is a diagram illustrating an example in which a stock-out process is performed with respect to an insufficient quantity;

FIG. 18 is a diagram illustrating the configuration of a priority determination device according to an embodiment of the present invention;

FIG. 19 is a flowchart of a priority determination method according to an embodiment of the present invention; and

FIG. 20 is a flowchart of a priority-based demand control method according to an embodiment of the present invention.

### BEST MODE FOR INVENTION

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

The term “connected to” or “coupled to” that is used to designate a connection or coupling of one element to another element includes both a case that an element is “directly connected or coupled to” another element and a case that an element is connected or coupled to another element via still another element. In this case, the term “directly connected to” or “directly coupled to” means that an element is connected or coupled to another element without intervention of any other element.

Unless specially defined, all terms (including technical and scientific terms) used in the description could be used as meanings commonly understood by those ordinary skilled in the art to which the present invention belongs. In addition, terms that are generally used but are not defined in the dictionary are not interpreted ideally or excessively unless they have been clearly and specially defined.

In the description, a singular expression may include a plural expression unless specially described. The term “comprises” and/or “comprising” used in the description means that one or more other components, steps, operation and/or existence or addition of elements are not excluded in addition to the described components, steps, operation and/or elements.

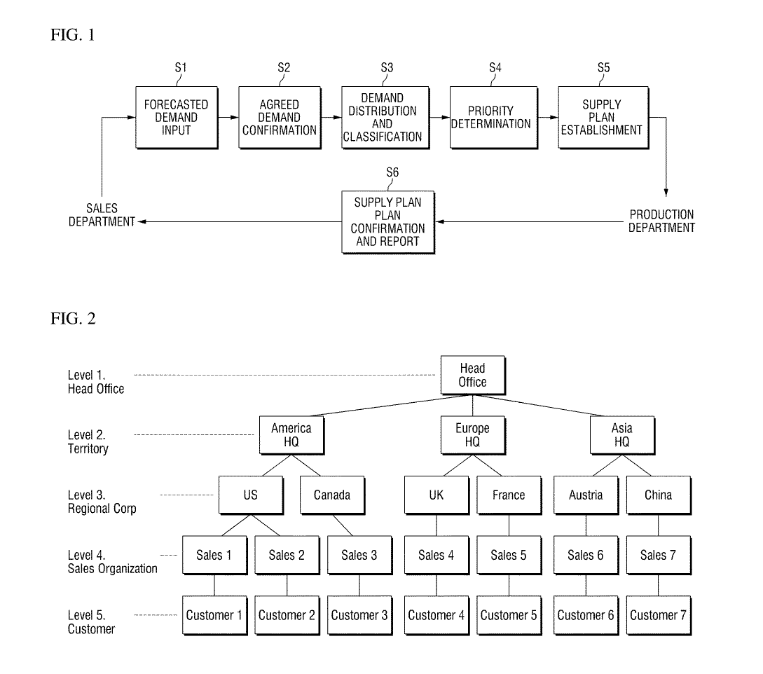

First, referring to FIG. 1, a forecasted demand and supply plan establishment process of an enterprise will be described. A sales organization forecasts the sales for the present and future scheduled period (planned period) pre-agreed with a production organization, and inputs forecasted values for a day, a week, or a month to an associated system (S1). The input values are confirmed as agreed demands through participators' conference (S2). The confirmed demands are analyzed and classified in accordance with the components of the confirmed demands using order information of which delivery is requested in a planned period and the existing confirmed supply plan information (S3). The priorities of the classified confirmed demands are determined in accordance with the pre-calculated profitability of the product and customer importance (S4). A supply plan of products that can be produced during a planned period is established (S5) through checking of materials that are necessary for production and availability of facilities that are necessary for assembly or processing with respect to the confirmed demands of which the priorities are determined (S5). The established supply plan is reported to the sales department after a production department finally examines and adjusts whether the supply plan can be executed (S6).

According to an embodiment, the present invention may be used in the priority determination process (S4) for determining the priorities for the respective classified items using the confirmed demand information that is analyzed and classified in accordance with the demand components in the forecasted demand and supply plan establishment process as illustrated in FIG. 1. However, the present invention may be used not only in the process (S3) of determining the priorities of the confirmed demands but also in other fields for applying the effects of the present invention.

FIG. 2 is a diagram illustrating an example of an organizational layer that determines priorities of confirmed demands of an enterprise having a global sales network.

The construction and the level of a priority determination organization or a sales organization may differ in each enterprise. FIG. 2 illustrates an example of a priority determination organization (or sales organization) that includes layers of a head office, a territory, a regional corporation, a sales organization, and a customer.

The priorities of the confirmed demands are determined using the confirmed demand information that is received from one or more low-level organizations, and the priority determination organization may be an organization having one or more low-level organizations. For example, in FIG. 2, the priority determination organization may be a head office, the head office of level 1, each territory of level 2, and each regional corporation of level 3.

The sales organization that is used to explain the present invention may be an enterprise, an organization, or a corporation of each level. That is, in FIG. 2, the sales organization may be a head office, America headquarters, Europe headquarters, Asia headquarters, US corporation, Canada corporation, UK corporation, France corporation, Australia corporation, China corporation, or each of sales 1 to sales 7.

The respective sales organizations may determine the priorities of the confirmed demands using the priority determination device 100 or a priority determination method according to the present invention.

Further, the priority information of the confirmed demands that are determined by a specific sales organization may be input to a high-level sales organization. The high-level sales organization may determine the priorities of the confirmed demands through reflection of the priorities of the respective sales organizations that are input by the low-level sales organizations.

Further, the priorities of the confirmed demands of the low-level sales organizations may be determined through reception of an input of the confirmed demand information from the low-level sales organizations at the head office level, the territory level, or the regional corporation level. The confirmed demand information is information related to the demands input from the lower organizations of the respective levels, and includes information on preset items.

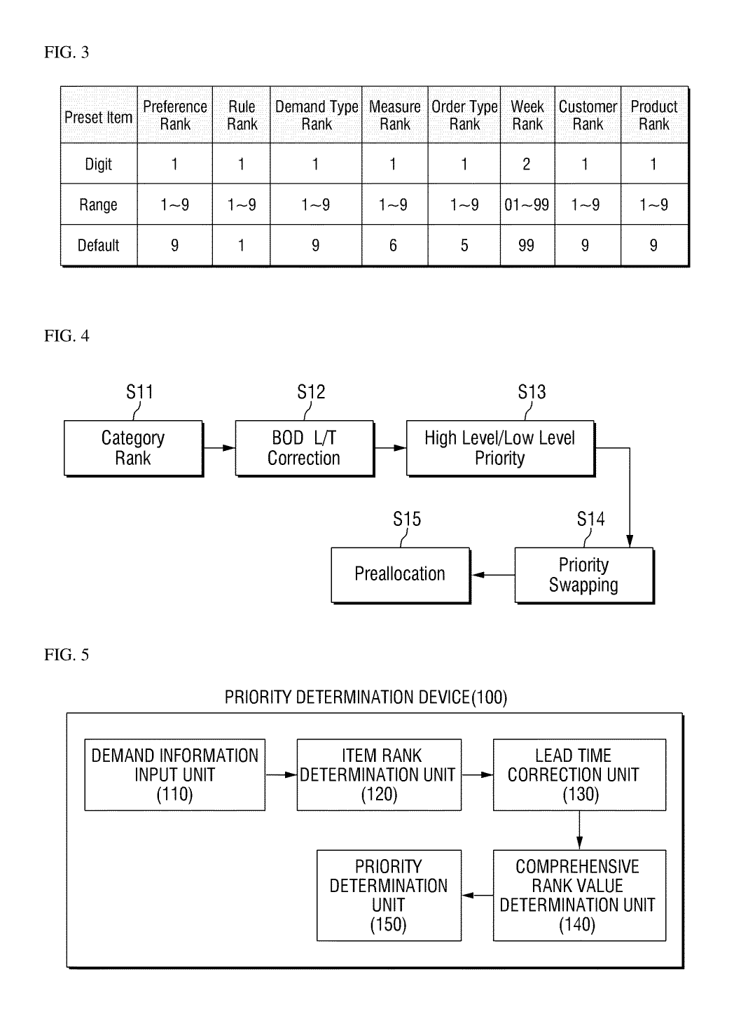

The preset items may be set as the items that can be used to determine the priorities, and for example, the reset items may be set as shown in FIG. 3.

FIG. 3 is a diagram illustrating an example of preset items.

Referring to FIG. 3, the preset items may include a preference rank that is an item related to importance of a customer, a demand type rank that is an item related to a demand type, a measurement rank that is an item related to an information input subject, an order type rank that is an item related to an order attribute, a week rank that is an item related to demand request time, a customer rank that is an item related to a customer according to profit and loss results, and/or a product rank that is an item related to products according to the profit and loss results.

However, the preset items are not limited to the items in the example of FIG. 3, but may be changed due to various reasons, such as enterprise conditions, kind of products, type of enterprise organizations, and market conditions.

Further, for easy discrimination and understanding, the item related to the demand request time is named “week rank”, but such naming does not mean that the demand request time is determined in the unit of a week. That is, the demand request time may be determined in various time units, such as in the unit of a day, a month, or an hour.

Determination of the priorities of the confirmed demands is to successively determine the priorities of the confirmed demands of several lower organizations, starting from the confirmed demand of which the priority should be determined most preferentially using information included in the respective confirmed demands. The determination of the priorities of the confirmed demands is required when there is no supply that satisfies all the confirmed demands requested by the lower organizations, when preparing the standard for controlling the demand or the supply in the corporate strategy, or for the profit and future of an enterprise in consideration of the profitability.

FIG. 4 is a flowchart explaining a priority determination method and a priority-based demand control method according to the present invention.

Referring to FIG. 4, a priority determination method according to the present invention will be briefly described.

In FIG. 4, a category rank step S11 may determine rank values for respective items using information on preset items included in confirmed demand information that is input from respective low-level sales organization.

A BOD L/T (Bill Of Distribution Lead Time) correction step S12 may correct the rank values of a week rank that is an item related to a demand request time in a category rank in consideration of a lead time of a BOD (Bill Of Distribution).

A high-level/low-level priority step S13 may determine a unified comprehensive priority value through arrangement of values of each category rank on the basis of a high-level rule that is an enterprise priority policy. On the other hand, if a regional priority policy has been designated, a different comprehensive priority value may be determined through rearrangement of the category ranks on the basis of a low-level rule that is set for each sales organization or sales region.

The high-level/low-level priority step S13 may determine the comprehensive priority value using the rank value for each item in which rank value information that is corrected by the BOD L/T correction step S12 is reflected.

A priority swapping step S14 may align demands in the order of priority on the basis of the comprehensive priority value that is determined by the low-level rule, and may reflect the aligned ranks in the priorities determined on the basis of the comprehensive priority value that is determined by a high-level rule.

The priorities of the confirmed demands may be determined using the steps S11 to S14 of FIG. 4, and if needed, the order of the steps S11 to S14 may be changed or a specific step may be omitted.

Continuously referring to FIG. 4, a priority-based demand control method according to the present invention will be described.

A preallocation step S15 may limit the demand quantity on the basis of the priorities of the confirmed demands that are determined by the priority determination method according to the present invention, or a stock-out process may be performed with respect to the confirmed demand quantity that exceeds the limited demand quantity.

The respective steps S11 to S15 as described above with reference to FIG. 4, and the priority determination method and the priority-based demand control method according to the present invention will be described in more detail with reference to FIGS. 5 to 17.

FIG. 5 is a block diagram of a priority determination device 100 according to an embodiment of the present invention.

Referring to FIG. 5, a priority determination device 100 according to an embodiment of the present invention may include a demand information input unit 110, an item rank determination unit 120, a lead time correction unit 130, a comprehensive rank value determination unit 140, and a priority determination unit 150.

The demand information input unit 110 may receive an input of confirmed demand information that includes information on preset items from respective low-level sales organizations.

The preset items may be as described above with reference to FIG. 3, and may be changed due to various reasons, such as enterprise conditions, kind of products, type of enterprise organizations, and market conditions.

The information on the preset items that are input through the demand information input unit 110 may include enterprise detailed item information set for each item. For example, in a demand type rank that is an item related to a demand type among the preset items, detailed selection information may be set, such as a quantity COM_ORD pre-planned to be supplied with respect to a sales order quantity, a quantity COM_FCST engaged to be pre-supplied with respect to a pure forecasted demand quantity from which the sales order quantity is subtracted, a sales order quantity NEW_ORD that exceeds the quantity engaged to be pre-supplied, a pure forecasted demand quantity NEW_FCST that exceeds the quantity engaged to be pre-supplied, and a sales order quantity UNF_ORD that exceeds the forecasted demand quantity. As another example, in an item related to an order attribute among the preset items, detailed selection information may be set, such as shipment GI, delivery instructions DO, engagement of delivery time CO, and order reception only NO.

That is, the information that is input through the demand information input unit 110 may include selected detailed information for preset items. If there is not selected detailed information in the information that is input through the demand information input unit 110, it may be processed as a default.

The item rank determination unit 120 may determine rank values for the preset items using the confirmed demand information that is input through the demand information input unit 110.

The rank values that are indicated by the respective pieces of detailed selection information existing for the preset items may be preset, and the item rank determination unit 120 may determine the rank values corresponding to the selected detailed information in accordance with the preset rank values.

For example, the item rank determination unit 120 may determine a week rank that is an item related to a demand request time with a two-digit number, and may determine other items except for the week rank that is the item related to the demand request time with one-digit numbers.

Specifically, referring to FIG. 3, the item rank determination unit 120 may determine the number in the range of 1 to 9 as the rank value on the basis of the detailed selection information with respect to a preference rank that is an item related to importance of a customer. In the same manner, the item rank determination unit 120 may determined the number in the range of 1 to 9 as the rank value on the basis of the detailed selection information even with respect to a demand type rank that is an item related to a demand type, a measurement rank that is an item related to an information input subject, an order type rank that is an item related to an order attribute, a customer rank that is an item related to a customer according to profit and loss results, and a product rank that is an item related to products according to the profit and loss results.

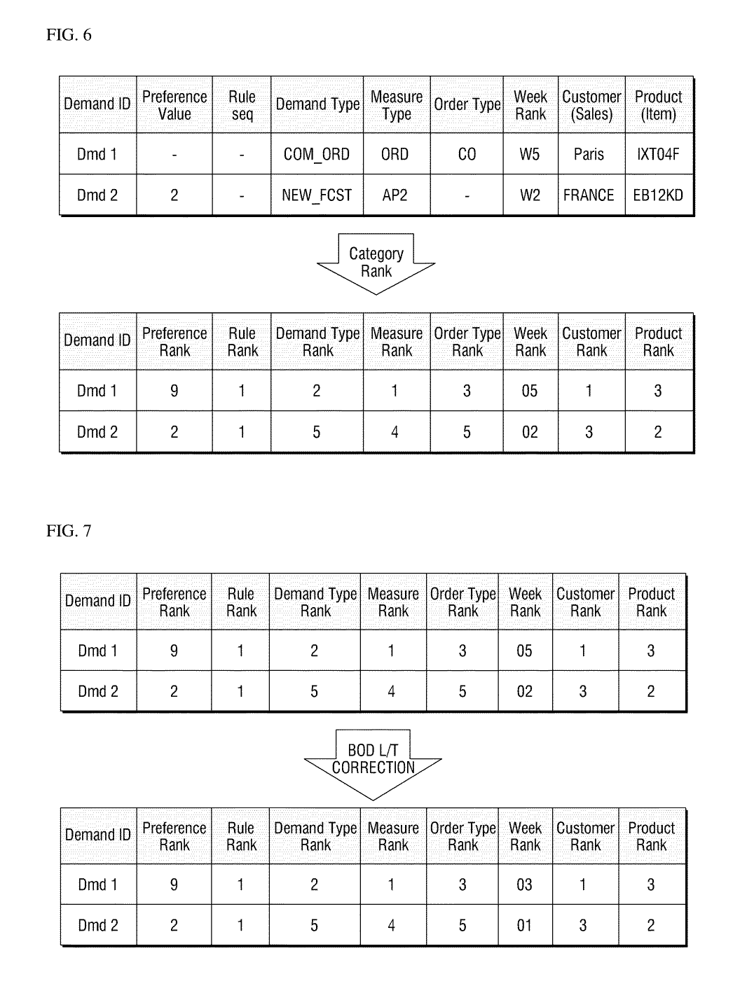

The item rank determination unit 120 may determine the number in the range of 1 to 9 as the rank value on the basis of the detailed selection information with respect to the week rank that is the item related to the demand request time. Since the demand request time may be 10 weeks or more, the item rank determination unit 120 may determine the rank value with a two-digit number, and may determine the rank values through expression of the number in the range of 1 to 9 as two-digit number in the range of 01 to 09 for consistency of the two-digit numbers. Referring to FIG. 6, the item rank determination unit 120 will be exemplarily described.

FIG. 6 is a diagram illustrating an example in which rank values for items are determined by an item rank determination unit 120.

Referring to FIG. 6, an example in which the item rank determination unit 120 determines the rank values for the respective items using the information that is input through the demand information input unit 110 will be described. In a table positioned at an upper end of FIG. 6, “Demand ID” is an identifier for discriminating confirmed demands. A different “Demand ID” may mean a different sales organization that inputs confirmed demand information, and may be information related to a confirmed demand that is discriminatingly input due to a different request time or the like even in the case of the same sales organization that inputs the confirmed demand information.

“Rule Seq” indicates information on which of the high-level rule and the low-level rule will follow. That is, the “Rule Seq” is an item that contains information related to a rule being used in the case where different rules are used for sections when the comprehensive priority value is determined by the comprehensive rank value determination unit 140 to be described in detail later. In the case where different rules are not used for sections during determination of the comprehensive priority value, the corresponding item may not exist.

The table that is positioned at the upper end of FIG. 6 indicates detailed information for items input by the demand information input unit 110, and the table that is positioned at the lower end of FIG. 6 is a table that represents an example in which rank values that correspond to the detailed information for respective items are determined by the item rank determination unit 120.

Continuously referring to FIG. 6, it can be known that each item includes detailed information. That is, it can be known that information on a demand type item of a confirmed demand Dmd 1 is COM-ORD and information on a demand type item of a confirmed demand Dmd 2 is NEW_FCST. The item rank determination unit 120 may determine the rank value “2” that corresponds to COM_ORD in the demand type item as the rank value of the demand type item of Dmd 1 on the basis of the preset items. Further, the item rank determination unit 120 may determine the rank value “5” that corresponds to NEW_FCST in the demand type item as the rank value of the demand type item of Dmd 2 on the basis of the preset items.

Referring to FIG. 6, another example will be further described. The item rank determination unit 120 may determine the rank values of the week rank item for each confirmed demand using information W5 and W2 on the week rank items of Dmd 1 and Dmd 2. As shown in table that is positioned at the lower end of FIG. 6, it can be seen that the rank value of the week rank item of Dmd 1 that is determined by the item rank determination unit 120 is 05, and the rank value of the week rank item of Dmd 2 is 02.

With respect to other items, the item rank determination unit 120 may determine the rank values for the respective items of the confirmed demands. What is the rank value that is indicated by the detailed selection information may be preset as described above. However, such setting may be changed in accordance with various conditions, such as enterprise conditions, market conditions, and product kinds. That is, although it is preset in FIG. 6 that the detailed information COM_ORD that is selected from the demand type item indicates the rank value “2”, it may be set to indicate another rank value, for example, “3” in different conditions of the same enterprise.

If the selected detailed information of a specific item does not exist in the confirmed demand information, the item rank determination unit 120 may process the rank value as a default and may determine the rank value that is indicated by the default as the rank value of the corresponding item. The rank value that is indicated by the default may be preset for each item. Referring to FIG. 6, since there is not preference value information that is information corresponding to the preference rank item of the confirmed demand Dmd1, the corresponding item is processed as a default, and the rank value “9” that is indicated by the default of the preference rank item may be determined as the rank value of the preference rank item of Dmd 1.

Examples of the rank value that is indicated by the default for each item may be as illustrated in FIG. 3, and may be changed due to various reasons, such as market conditions or enterprise environments.

The lead time correction unit may correct the week rank that is an item related to a demand request time that related to the lead time among the rank values for the respective items determined by the item rank determination unit 120 using lead time information of the BOD (Bill Of Distribution).

Specifically, the BOD means a table in which a transport path, a transport means, and a movement time of a product are set when movement of a product between regions, that is, product transport is planned. That is, the lead time correction unit 130 corrects the week rank through reflection of a BOD lead time taken from a producing center to a corporate DC (Distribution Center) or a destination.

Referring to FIG. 7, an example in which rank values for week time items are corrected by the lead time correction unit 130 will be described.

FIG. 7 is a diagram explaining an example in which rank values for week time items are corrected by a lead time correction unit 130.

Referring to FIG. 7, a table that is positioned at an upper end portion of FIG. 7 is a table that indicates rank values for items of different confirmed demands determined by the item rank determination unit 120. In the table that is positioned at the upper end portion of FIG. 7, the rank values of the week rank item is set so that the rank value of the corresponding item of the confirmed demand Dmd 1 is 05 and the rank value of the corresponding item of the confirmed demand Dmd 2 is 02.

It is assumed that a lead time in which a demand request product IXT04F (product corresponding to product rank 3, see FIG. 6) of the confirmed demand Dmd 1 moves from a producing center to a destination Paris sales organization (destination corresponding to customer rank 1, see FIG. 6) is two weeks, and a lead time in which a demand request product EB12KD (product corresponding to product rank 3, see FIG. 6) of the confirmed demand Dmd 2 moves from a producing center to a destination France sales organization (destination corresponding to customer rank 1, see FIG. 6) is one week.

In this case, referring to the table that is positioned at the lower end portion of FIG. 7, the lead time correction unit 130 may correct the rank value of the week rank item of Dmd 1 from 05 to 03 that is obtained by subtracting a lead time of 2 weeks from 05 and the rank value of the week rank item of Dmd 2 from 02 to 01 that is obtained by subtracting a lead time of 1 week from 02 through reflection of the lead times of the respective confirmed demands.

If the lead time correction unit 130 does not correct the rank values through reflection of the lead times, a specific sales organization having a relatively long BOD lead time becomes unprofitable in comparison to other sales organizations having a relatively short BOD lead time, and a production plan and a supply plan may fail.

The comprehensive rank value determination unit 140 may determine the comprehensive priority value through arrangement of the rank values for the respect items that are determined by the item rand determination unit 120 in accordance with a preset rule. Preferably, the comprehensive rank value determination unit 140 may determine the comprehensive priority value through arrangement of the rank values for the respect items that are corrected by the lead time correction unit 130 in accordance with the preset rule.

The preset rule may include a high-level rule that is set by an enterprise and a low-level rule that is set in consideration of the conditions of the respective sales organizations and is different from the high-level rule.

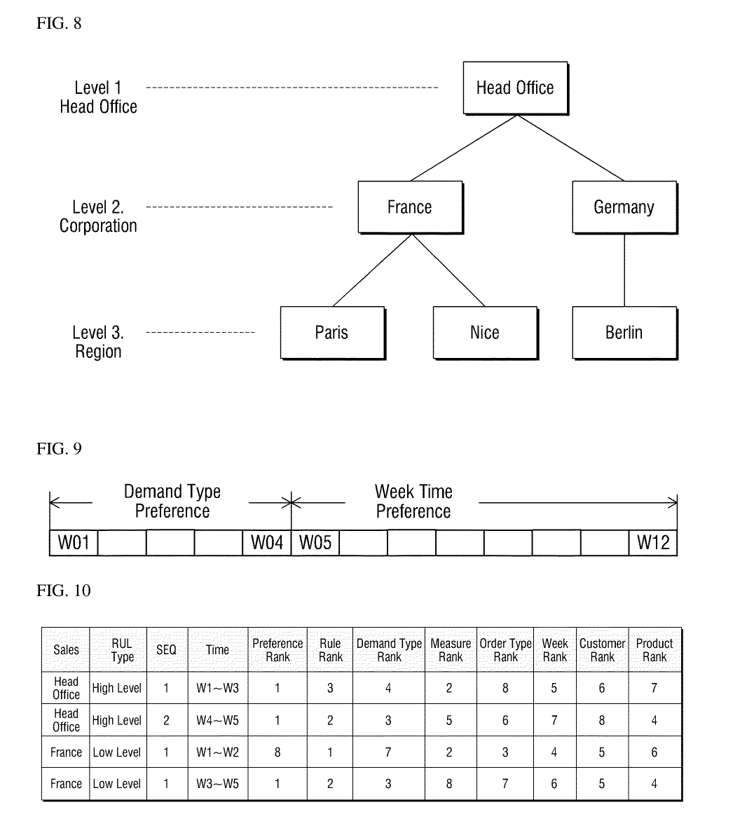

The low-level rule may exist for each sales organization, and there may be a sales organization in which the low-level rule does not exist. Further, two or more different sales organizations may have the same low-level rule. This will be exemplarily described with reference to FIG. 8.

FIG. 8 is a diagram illustrating an example of a sales organization layer.

Referring to FIG. 8, the high-level rule is determined by a head office of level 1, and the determined high-level rule may be used to determine the comprehensive priority value through respective organizations of level 2 and level 3. Further, the respective organizations of level 2 and level 3 may be used to determine the comprehensive priority value through determination of the low-level rule in consideration of the specified conditions of the corresponding regions. For example, France corporation of level 2 may determine the low-level rule, and organizations of Paris and Nice regions of level 3 may use the low-level rule that is set in the France corporation to determine the comprehensive priority value. In the case of Germany, only the high-level rule may be used, and a separate low-level rule may not be determined.

That is, the preset rule may include the high-level rule that is determined by the highest-level organization and the low-level rule that is set by the low-level organization that is not the highest-level organization.

However, the enterprise or highest-level organization that determines the high-level rule may not be the organization that corresponds to the highest level in the enterprise organizations. Specifically, even the organization of the level that is not the organization that corresponds to the highest-level in the enterprise organizations may become the enterprise or highest-level organization that determines the high-level rule in consideration of sales environments, regions, organization structures, and business environments.

That is, in FIG. 8, not only the head office organization but also the organization of France region may be the highest-level organization that can determine the high-level rule.

FIG. 9 is a diagram explaining an example in which a preset rule is differently applied in accordance with conditions.

The high-level rule and the low-level rule may be set to be differently applied in accordance with the conditions. For example, referring to FIG. 9, in the case where the week rank value is 01 to 04 (W1 to W4 in FIG. 9), the preset rule may be set to determine the comprehensive priority value in first consideration of the demand type. In contrast, in the case where the week rank value is 05 to 12 (W5 to W12 in FIG. 9), the preset rule may be set to determine the comprehensive priority value in first consideration of the rank value of the week time.

FIG. 10 is a diagram illustrating an example in which a high-level rule and a low-level rule are set.

Referring to FIG. 10, the term “RULE Type” represents information related to an applied preset rule type. The term “SEQ” represents an identification number of a rule that is discriminated according to the conditions in the case where the preset rule is differently set in accordance with the conditions. The term “Time” represents a condition to determine the preset rule to be finally applied. That is, “SEQ” may be determined in accordance with the conditions. Such conditions may be changed.

That is, in the case where “RULE Type” is high level, “SEQ” is “1”, “Time” is W1 to W3, and the selected detailed information of the week rank is 01 to 03, it means that the comprehensive priority value is determined through application of “1” of the high-level rule.

The numbers of the items from “Preference Rank” to “Product Rank” may mean the order of arrangement of the rank values of the items that are determined by the item rank determination unit 120 (or rank values to which the rank values that is corrected by the lead correction unit is applied).

Referring to FIGS. 10 and 11, an example of the comprehensive priority value that is determined by the comprehensive rank value determination unit will be described.

FIG. 11 is a diagram illustrating an example of a comprehensive priority value determined by a comprehensive rank value determination unit.

Referring to a table that is positioned at an upper end portion of FIG. 11, the rank values that are determined for the respective items of different confirmed demands Dmd 1 and Dmd 2 are presented. The rank values 03 and 01 of the week rank item among the determined rank values may be rank values corrected by the lead correction unit.

In a table that is positioned at a lower end portion of FIG. 11, week rank values are information that determines the conditions of the preset rule that are differently applied for sections.

W5 and W2 correspond to detailed information that is indicated by the rank values of the week rank item before being corrected by the lead correction unit. This can be known more clearly with reference to FIGS. 6 and 7.

Among the confirmed demands, the comprehensive priority values of Dmd 1 will be first described. In the case where the week information of Dmd 1 is W5, and the high-level rule is applied thereto, the comprehensive rank value determination unit 140 may determine the comprehensive priority value of Dmd 1 through arrangement of the respective item rank values in accordance with the rule in which “SEQ” is “2” in the high-level rule of FIG. 10.

Specifically, referring to FIG. 10, it can be known that “Preference Rank” is the first rank, “Rule Rank” is the second rank, “Demand Type Rank” is the third rank, “Product Rank” is the fourth rank, “Measure Rank” is the fifth rank, “Order Type Rank” is the sixth rank, “Week Rank” is the seventh rank, and “Customer Rank” is the eighth rank. In accordance with such ranks, the respective item rank values of Dmd 1 are arranged as 9 1 2 3 1 3 03 1. That is, the comprehensive rank value determination unit 140 may determine the comprehensive priority value as 912313031 through arrangement of the respective item rank values of the confirmed demand Dmd 1 in accordance with the second rule of the high-level rule.

The comprehensive priority values that are determined by the comprehensive rank value determination unit 140 may appear differently in accordance with the change of the preset items, the setting of the rank value indicated by default, and the setting of rank values indicated by the detailed information of the respective items. Further, it is not necessary that the comprehensive priority value is in the form of a number, and may be presented by various alphabets.

In the case of determining the comprehensive priority value of Dmd 1 by France low-level rule, it corresponds to the condition of W5, and the comprehensive rank value determination unit 140 may apply the second rule of the France low-level rule. The confirmed demand that corresponds to Dmd 1 may be determined to follow the low-level rule that is set by France corporation since Paris corporation or a low-level rule set by the Paris corporation does not exist. France corporation is an upper-level organization than Paris corporation, and is a lower-level organization than the head office. However, in the case where the low-level rule that is set by Paris corporation exists separately, the confirmed demand may follow the corresponding set rule, and in this case, the comprehensive priority value may differ.

That is, if the respective item rank values of FIG. 11 are arranged in accordance with the respective item arrangement order that is indicated on the last line of FIG. 10, the comprehensive value determination unit 140 may determine the comprehensive priority value of Dmd 1 as 9123110331.

In the case of determining the comprehensive priority value of Dmd 2 by the high-level rule, it corresponds to the condition of W2, and thus the comprehensive rank value determination unit 140 may determine the comprehensive priority value of Dmd 2 as 241501325 through application of the first rule SEQ 1 of the high-level rule.

Further, in the case of determining the comprehensive priority value of Dmd 2 by France low-level rule, it corresponds to the condition of W2, and thus the comprehensive rank value determination unit 140 may determine the comprehensive priority value of Dmd 2 as 145013252 through application of the first rule SEQ 1 of the low-level rule.

The priority determination unit 150 may determine the priorities of the respective confirmed demands using the comprehensive priority value of the respective confirmed demands determined by the comprehensive rank value determination unit 140. For example, the priority determination unit 150 may determine higher priority as the size of the comprehensive priority value becomes smaller.

Further, the priority determination unit 150 may determine the priorities of the respective confirmed demands through application of the comprehensive priority value of the respective confirmed demands to a preset functional equation.

If needed, the priority determination unit 150 may perform priority swapping.

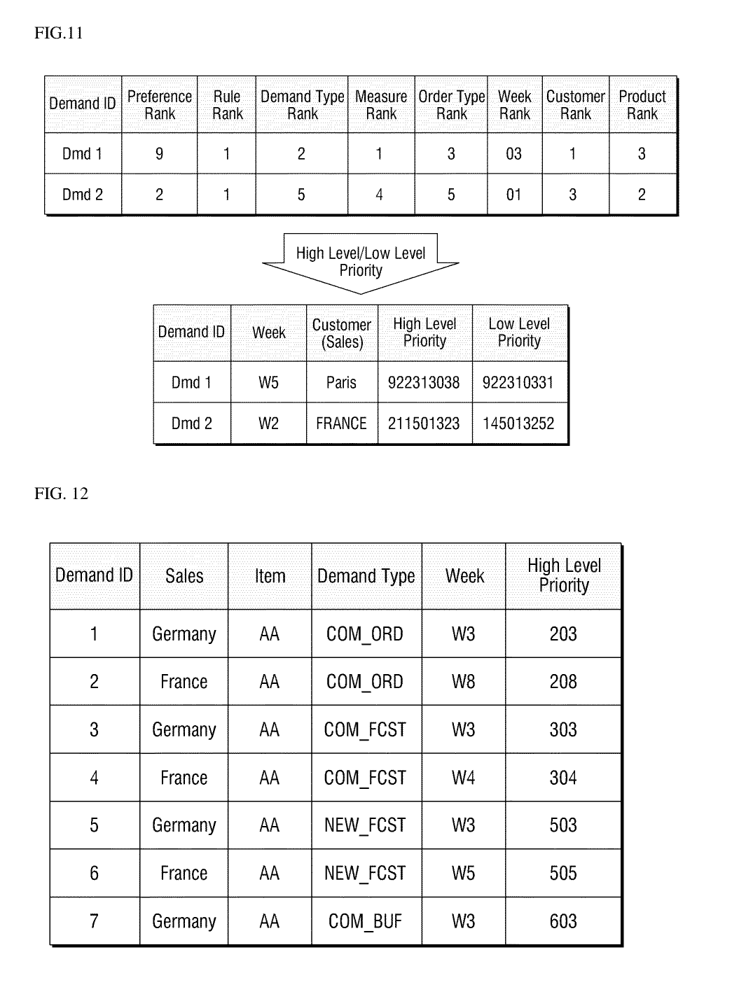

A case where priority swapping is required and a method in which the priority determination unit 150 performs priority swapping will be described with reference to FIGS. 12 to 14.

FIG. 12 is a diagram illustrating an example in which using the priority determination device 100 and the priority determination method according to the present invention, the Europe head office receives an input of information related to a demand type rank item and information related to a week rank item from respective sales regions in Germany and France, determines the comprehensive priority value using the high-level rule for each confirmed demand, and determines the priorities by the determined comprehensive priority value.

Continuously referring to FIG. 12, the comprehensive priority value that is determined by the comprehensive rank value determination unit 140 is described for each confirmed demand on the high-level priority item. The term “203” is a value that is obtained by arranging the rank value “2” indicated by COM_ORD and the rank value “03” indicated by COM_FCST in accordance with the arrangement according to the high-level rule. The term “304” is a value that is obtained by arranging the rank value “3” indicated by COM_FCST and the rank value “04” indicated by W4 in accordance with the arrangement according to the high-level rule.

That is, the high-level rule that can be known from FIG. 12 is a rule that prefers the demand type rank item that is an item of demand type information to the week rank item that is an item of week information. The setting of such a high-level rule may be changed.

In FIG. 12, it can be known that the priority of the confirmed demand having the small comprehensive priority value is positioned at an upper end of a high bar table, and the priority of the confirmed demand having the large comprehensive priority value is positioned at a lower end of the low bar table.

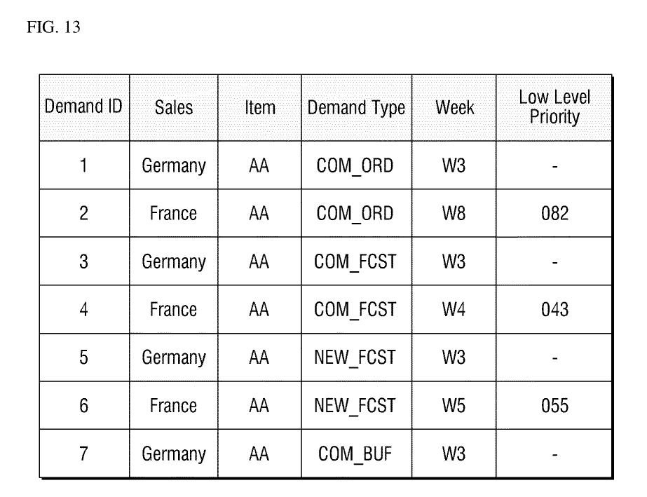

FIG. 13 is a diagram illustrating an example in which a comprehensive rank value is determined through application of a low-level rule in consideration of France characteristics in the case where the sales organization is France corporation or a low-level organization of the France corporation in the same confirmed demand information of FIG. 12.

Referring to FIG. 13, it can be known that the low-level rule of France sales organization is a rule that prefers the week rank item that is an item of the week information to the demand type rank item that is an item of the demand type information. Accordingly, if the comprehensive rank value determination unit 140 determines the comprehensive priority value of demand IDs 2, 4, and 6 corresponding to France sales organization in accordance with the low-level rule, “208” becomes “082”, “304” becomes “843”, and “505” becomes 505.

In the related art, if the comprehensive priority values of the sales organization to which the low-level rule is applied and the sales organization to which the high-level rule is applied coexist, the sales organization to which the low-level rule is applied may cause the sales organization to which the high-level rule is applied to be unprofitable. That is, if the determined comprehensive priority values of the demand IDs 2, 4, and 6 that are determined in FIG. 13 are applied to FIG. 12 in which the comprehensive priority values determined by the high-level rule are described, it can be known that all the demand IDs 2, 4, and 6 take the priorities that are higher than those of the demand IDs 1, 3, 5, and 7 that are the confirmed demands of Germany sales region.

In order to solve this problem, the priority determination unit 150 may perform priority swapping. That is, the priority determination unit 150 maintains the priority in accordance with the comprehensive priority value that is determined by the high-level rule. If the priority value is changed due to the low-level rule, the priority determination unit 150 may change the information through application of the corresponding changed rank only between the confirmed demands to which the corresponding low-level rule is applied among the comprehensive priority determined by the high-level rule.

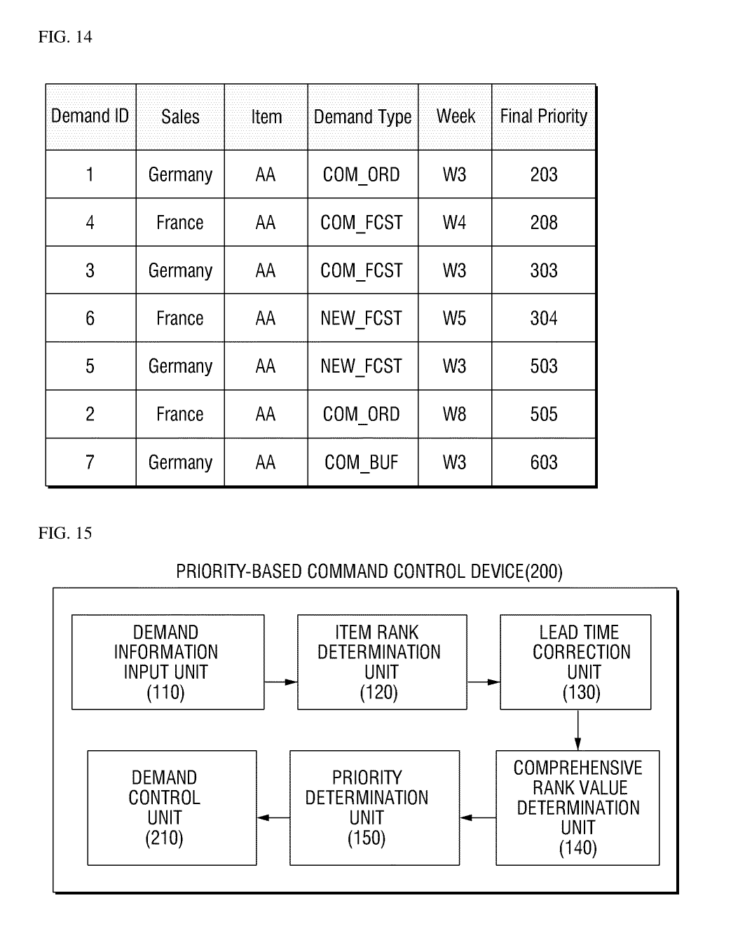

An example of the result that the priority determination unit 150 performs the priority swapping will be described with reference to FIG. 14.

Referring to FIG. 14, the result of reflection of the contents of FIG. 13 in FIG. 12. That is, the comprehensive priority value presented in FIG. 13 is not reflected in FIG. 12 as it is, but the order may be changed through application of the comprehensive priority value presented in FIG. 13 between the demand IDs 2, 4, and 6 of France sales organization to which the low-level rule is applied while the comprehensive priority value and the priorities in accordance with the high-level rule in FIG. 12 are maintained.

That is, continuously referring to FIG. 14, it can be known that the final ranks are changed in the order of demand IDs 1, 4, 3, 6, 5, 2, and 7 by changing the information through reflection of a case where the demand ID 4 is the most preferential rank, the demand ID 6 is the next rank, and the demand ID 2 is the lowermost rank in the France sales organization to which the low-level rule is applied.

The priority determination unit 150 may reflect the priority by the low-level rule that reflects the characteristics of the corresponding sales organization through performing of the priority swapping, and may also minimize the disadvantages of other sales organizations.

FIG. 15 is a block diagram of a priority-based demand control device 200 according to an embodiment of the present invention.

Referring to FIG. 15, a priority-based demand control device 200 according to an embodiment of the present invention may further include a demand control unit 210 in addition of the priority determination device 100.

The demand control unit 210 may successively distribute the predetermined supply plan quantities in the order of high (important) priorities that are determined by the priority determination unit 150.

Further, if the predetermined product quantity is smaller than the total quantity of the confirmed demands input by the respective sales organizations, the demand control unit 210 may successively distribute the predetermined supply plan quantity in the order of high priorities of the determined confirmed demands, and may perform a stock-out process with respect to the confirmed demand which has low priority and to which the supply plan quantity is not distributed so as not to establish the supply plan.

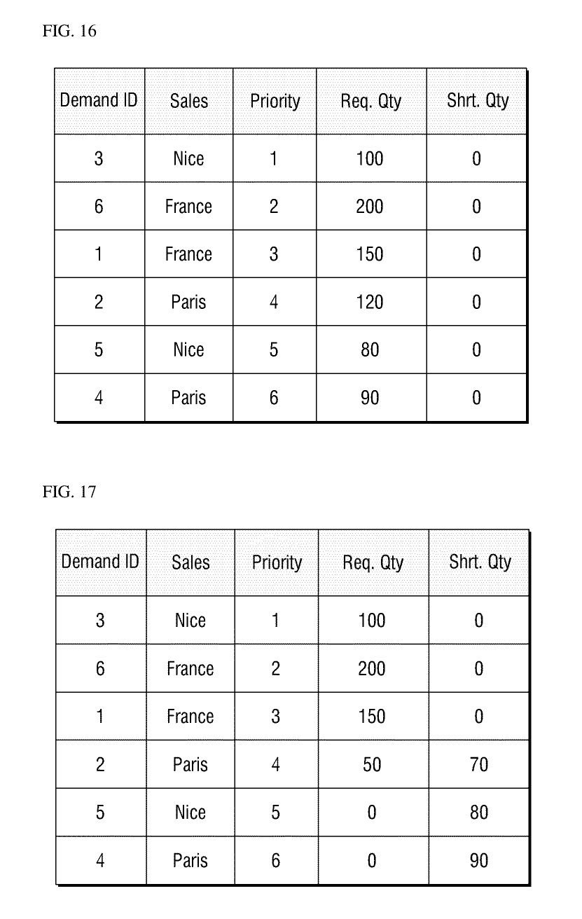

Specifically, referring to FIG. 16, confirmed demand request quantities Req. Qty are described in the order of priorities determined by the priority determination unit 150. If 500 product supply plans are established in consideration of the enterprise demand control or supply plan quantity, the demand control unit 210 may successively distribute the 500 products from the uppermost rank. In FIG. 16, the demand control unit 210 distributes the quantity 100 that is required by the confirmed demand of demand ID 3 that is the uppermost priority in 500, and then distributes the quantity 200 that is required by the confirmed demand of demand ID 6 that is the next priority in the remainder 400. In continuation, the demand control unit 210 distributes the quantity 150 that is required by the confirmed demand of demand ID 1 that is the third rank in the remainder 200. The supply plan quantity that remains after distribution up to the third rank becomes 50. The demand control unit 210 may distribute the remainder 50 to supplement the quantity 120 that is required by the confirmed demand of demand ID 2 that is the fourth rank. If the demand control unit 210 distributes the supply plan quantity in accordance with the priorities, the quantity 70 of the quantity 120 that is required by the confirmed demand of demand ID 2, the quantity 80 that is required by the confirmed demand of demand ID 5, and the quantity 90 that is required by the confirmed demand of demand ID 4 become finally short as shown in FIG. 16.

The demand control unit 210 may perform the stock-out process with respect to all the short quantity so as not to establish the supply plan. FIG. 17 illustrates an example in which the demand control unit 210 performs the stock-out process Shrt. Qty with respect to the short quantity in the situation of FIG. 16.

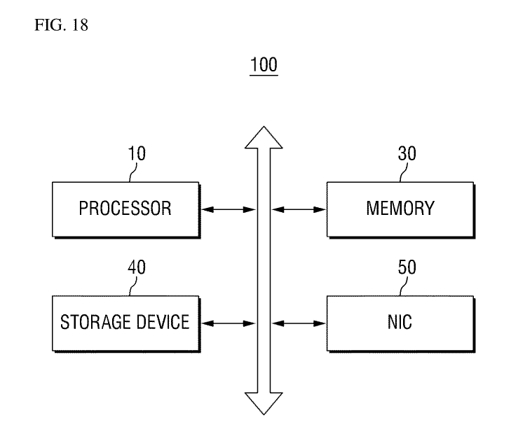

FIG. 18 is a diagram illustrating the configuration of a priority determination device 100 according to an embodiment of the present invention.

A priority determination device 100 according to an embodiment of the present invention may have the configuration as illustrated in FIG. 17. The priority determination device 100 may include a processor 10 that performs a command, a storage device 30 in which priority determination program data, input confirmed demand information data, preset item information, and rank value information data corresponding to detailed information are stored, a memory 40, and a network interface 50 for data transmission/reception with an external device.

In the storage device 30, a program, which performs receiving an input of confirmed demand information that includes information on preset items including a week rank that is an item related to a demand request time from respective low-level sales organizations, determining rank values for the preset items using the received confirmed demand information, correcting the determined rank value of the week rank among the determined rank values for the preset items in consideration of a lead time, determining a comprehensive priority value through arrangement of the determined rank values for the preset items that are corrected by the lead time correction in accordance with a preset rule, and determining priorities of the confirmed demands of the sales organizations using the comprehensive priority value, may be stored. The program may be performed through the processor 10 after being loaded to the memory. The program stored in the storage device 30 may perform at least one of the processes as described above with reference to FIGS. 3 to 17.

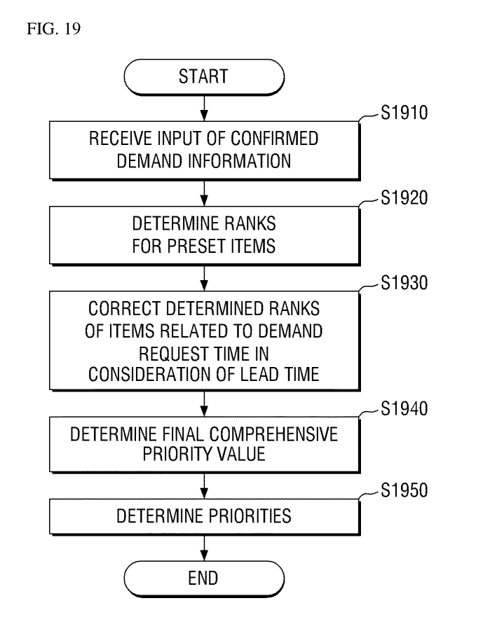

FIG. 19 is a flowchart of a priority determination method according to an embodiment of the present invention.

Referring to FIG. 19, the priority determination method according to an embodiment of the present invention will be described.

A demand information input unit 110 receives an input of confirmed demand information (S1910).

An item rank determination unit 120 may determine rank values for the preset items (S1920).

A lead time correction unit 130 may correct the rank value of a week rank that is an item related to a demand request time that is determined by the item rank determination unit 120 among the determined rank values for the preset items in consideration of a BOD lead time (S1930).

A comprehensive rank value determination unit 140 may determine a final comprehensive priority value using the determined rank values for the items in which the rank values that are corrected by the lead time correction unit 130 are reflected (S1940).

A priority determination unit 150 may determine priorities of the confirmed demands using the final comprehensive priority value.

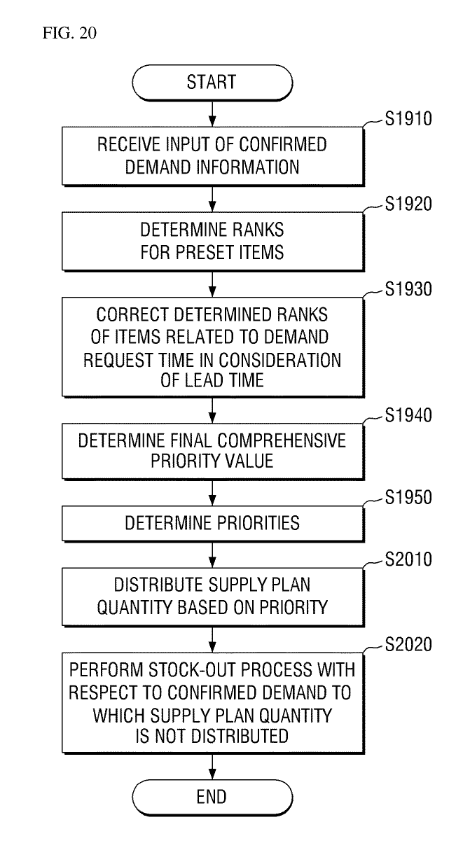

FIG. 20 is a flowchart of a priority-based demand control method according to an embodiment of the present invention.

Referring to FIG. 20, a priority-based demand control method according to an embodiment of the present invention will be described.

A demand control unit 210 may distribute predetermined supply plan quantities ion the basis of the priorities determined by S1910 to S1950 (S2010).

Further, the demand control unit 210 may perform a stock-out process with respect to the confirmed demand to which the supply plan quantity is not distributed so as not to establish the supply plan (S2020).

The contents of the priority determination device 100 and the priority-based demand control device 200 according to an embodiment of the present invention as described above with reference to FIGS. 1 to 18 can be applied to the priority determination method and the priority-based demand control method as described above with reference to FIGS. 19 and 20.

The priority determination device 100 and the priority determination method according to an embodiment of the present invention can provide the device and the method for determining priorities of confirmed demands.

Further, the priority determination device 100 and the priority determination method according to an embodiment of the present invention can be flexibly applied even in various business types and market conditions to determine the priorities of the confirmed demands.

Further, the priority determination device 100 and the priority determination method according to an embodiment of the present invention can determine priorities that can be structured, standardized, and flexibly changed in accordance with the market change, strategy of an enterprise, and product profitability.

Further, the priority determination device 100 and the priority determination method according to an embodiment of the present invention can determine priorities, which can respect the priority determination methods for several sales organizations and can prevent the priorities of other sales organizations from becoming unprofitable due to the respect of the priority determination method of a specific sales organization.

Further, the priority determination device 100 and the priority determination method according to an embodiment of the present invention can promptly apply product supply plans through determination of the priorities of the confirmed demands and can efficiently and continuously maintain and manage the demands and the supply plans.

Further, the priority-based demand control device 200 and the priority-based demand control method according to an embodiment of the present invention can control the total quantity of the confirmed demands in accordance with the demand conditions, supply conditions, and market conditions.

The respective constituent elements of FIGS. 5 and 15 may mean software or hardware, such as FPGA (Field-Programmable Gate Array) or ASIC (Application-Specific Integrated Circuit). However, the above constituent elements are not limited to the software or hardware, but may be configured to be in an addressable storage medium or may be configured to execute one or more processors. Functions that are provided in the constituent elements may be implemented by further detailed constituent elements, and may be implemented by one constituent element through addition of a plurality of constituent elements to perform specific functions.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A priority determination device comprising:
at least one processor configured to execute:
a demand information input unit configured to receive confirmed demand information comprising information on preset items including a week rank that is an item related to a demand request time, the information on the preset items being from respective low-level sales organizations of sales organizations;
an item rank determination unit configured to determine rank values for the preset items using the received confirmed demand information; and
a comprehensive rank value determination unit configured to determine a comprehensive priority value through arrangement, by a preset rule, of the determined rank values for the preset items that are determined by the item rank determination unit.

2. The priority determination device of claim 1, the at least one processor further configured to execute a lead time correction unit configured to correct a determined rank value of the week rank among the determined rank values for the preset items, the determined rank value being corrected based on a lead time,
wherein the comprehensive rank value determination unit determines the comprehensive priority value through the arrangement, by the preset rule, of the determined rank values for the preset items that are corrected by the lead time correction unit.

3. The priority determination device of claim 1, the at least one processor further configured to execute a priority determination unit configured to determine priorities of confirmed demands of the sales organizations using the comprehensive priority value.

4. The priority determination device of claim 3, wherein the preset rule includes a high-level rule that is determined by a highest-level organization and a low-level rule that is determined by a low-level organization that is not the highest-level organization, and
the comprehensive rank value determination unit determines the comprehensive priority value through the arrangement of the determined rank values for the preset items in accordance with at least one from among the high-level rule and the low-level rule.

5. The priority determination device of claim 4, wherein the priority determination unit determines a priority PR1 using the comprehensive priority value that is determined using the high-level rule,
when there exist sales organizations having the low-level rule among the sales organizations, the priority determination unit determines a priority PR2 between the sales organizations having the low-level rule, based on the comprehensive priority value that is determined using the low-level rule, and
the priority determination unit reflects the priority PR2 in the priority PR1 while not correcting a determined priority of the sales organizations that do not have the low-level rule.

6. The priority determination device of claim 1, wherein the preset items include at least one from among a preference rank that is an item related to importance of a customer, a demand type rank that is an item related to a demand type, a measurement rank that is an item related to an information input subject, an order type rank that is an item related to an order attribute, a customer rank that is an item related to a customer according to profit and loss results, and a product rank that is an item related to products according to profit and loss results.

7. A priority determination method comprising:
a demand information input operation of receiving confirmed demand information comprising information on preset items including a week rank that is an item related to a demand request time, the information on the preset items being from respective low-level sales organizations of sales organizations;
an item rank determination operation of determining rank values for the preset items using the received confirmed demand information; and
a comprehensive rank value determination operation of determining a comprehensive priority value through arrangement, by a preset rule, of the determined rank values for the preset items that are determined by the item rank determination operation.

8. The priority determination method of claim 7, further comprising a lead time correction operation of correcting a determined rank value of the week rank among the determined rank values for the preset items, the determined rank being corrected based on a lead time,
wherein the comprehensive rank value determination operation determines the comprehensive priority value through the arrangement, by the preset rule, of the determined rank values for the preset items that are corrected by the lead time correction operation.

9. The priority determination method of claim 7, further comprising a priority determination operation of determining priorities of confirmed demands of the sales organizations using the comprehensive priority value.

10. The priority determination method of claim 9, wherein the preset rule includes a high-level rule that is determined by a highest-level organization and a low-level rule that is determined by a low-level organization that is not the highest-level organization, and
the comprehensive rank value determination operation determines the comprehensive priority value through the arrangement of the determined rank values for the preset items in accordance with at least one from among the high-level rule and the low-level rule.

11. The priority determination method of claim 10, wherein the priority determination operation determines a priority PR1 using the comprehensive priority value that is determined using the high-level rule,
when there exist sales organizations having the low-level rule among the sales organizations, the priority determination operation determines a priority PR2 between the sales organizations that have the low-level rule based on the comprehensive priority value that is determined using the low-level rule, and
the priority determination operation reflects the priority PR2 in the priority PR1 while not correcting a determined priority of the sales organizations that do not have the low-level rule.

12. The priority determination method of claim 7, wherein the preset items include at least one from among a preference rank that is an item related to importance of a customer, a demand type rank that is an item related to a demand type, a measurement rank that is an item related to an information input subject, an order type rank that is an item related to an order attribute, a customer rank that is an item related to a customer according to profit and loss results, and a product rank that is an item related to products according to profit and loss results.

13. A priority-based demand control device comprising:
at least one processor configured to execute:
a demand information input unit configured to receive confirmed demand information that comprises information on preset items including a week rank that is an item related to a demand request time, the information on the preset items being from respective low-level sales organizations of sales organizations;
an item rank determination unit configured to determine rank values for the preset items using the received confirmed demand information;
a comprehensive rank value determination unit configured to determine a comprehensive priority value through arrangement, by a preset rule, of the determined rank values for the preset items that are determined by the item rank determination unit;
a priority determination unit configured to determine priorities of confirmed demands of the sales organizations using the comprehensive priority value; and
a demand control unit configured to successively distribute predetermined supply plan quantities in an order of the determined priorities of the confirmed demands.

14. The priority-based demand control device of claim 13, the at least one processor further configured to execute a lead time correction unit configured to correct the determined rank value of the week rank among the determined rank values for the preset items, the determined rank value being corrected based on a lead time,
wherein the comprehensive rank value determination unit determines the comprehensive priority value through the arrangement, the preset rule, of the determined rank values for the preset items that are corrected by the lead time correction unit.

15. The priority-based demand control device of claim 13, wherein the demand control unit successively distributes the predetermined supply plan quantities in the order of the determined priorities of the confirmed demands when predetermined product quantity is smaller than a total quantity of the confirmed demands input by the sales organizations, and performs a stock-out process with respect to the confirmed demand to which the supply plan quantity is not distributed.

16. A priority-based demand control method comprising:
a demand information input operation of receiving confirmed demand information that comprises information on preset items including a week rank that is an item related to a demand request time, the information on the preset items being from respective low-level sales organizations of sales organizations;
an item rank determination operation of determining rank values for the preset items using the received confirmed demand information;
a comprehensive rank value determination operation of determining a comprehensive priority value through arrangement, by a preset rule, of the determined rank values for the preset items that are determined by the item rank determination operation;
a priority determination operation of determining priorities of confirmed demands of the sales organizations using the comprehensive priority value; and
a demand control operation of successively distributing predetermined supply plan quantities in an order of the determined priorities of the confirmed demands.

17. The priority-based demand control method of claim 16, further comprising a lead time correction operation of correcting the determined rank value of the week rank among the determined rank values for the preset items, the determined rank value being corrected based on lead time,
wherein the comprehensive rank value determination operation determines the comprehensive priority value through the arrangement, the preset rule, of the determined rank values for the preset items that are corrected by the lead time correction operation.

18. The priority-based demand control method of claim 16, wherein the demand control operation successively distributes the predetermined supply plan quantities in the order of the determined priorities of the confirmed demands when predetermined product quantity is smaller than a total quantity of the confirmed demands input by the sales organizations, and performs a stock-out process with respect to the confirmed demand to which the supply plan quantity is not distributed.

19. A computer readable recording medium recorded with a program that causes at least one processor to perform:
receiving confirmed demand information that comprises information on preset items including a week rank that is an item related to a demand request time, the information on the preset items being from respective low-level sales organizations of sales organizations;
determining rank values for the preset items using the received confirmed demand information;
correcting the determined rank value of the week rank among the determined rank values for the preset items in consideration of a lead time;
determining a comprehensive priority value through arrangement, by a preset rule, of the determined rank values for the preset items that are corrected by the lead time correction; and
determining priorities of the confirmed demands of the sales organizations using the comprehensive priority value.
